(19) United States
(12) Patent Application Publication
(10) Pub. No.: US 2007/0134578 A1
(43) Pub. Date: Jun. 14, 2007

(54) Electrophotographic developing agent

(76) Inventors: Seok-hoon Choi, Suwon-si (KR); Sang-deok Kim, Gwangmyeong-si (KR); Duck-hee Lee, Seoul (KR)

Correspondence Address: STANZIONE & KIM, LLP, 919 18TH STREET, N.W., SUITE 440, WASHINGTON, DC, 20006, US

(21) Appl. No.: 11/553,031

(22) Filed: Oct. 26, 2006

(30) Foreign Application Priority Data
Dec. 13, 2005 (KR) 2005-122436

(51) Int. Cl. G03G 9/08; G03G 9/00; C09C 1/36; C01G 23/04; C01G 23/00

(52) U.S. Cl. 430/108.2; 430/108.6; 430/108.4; 430/108.8; 430/108.7; 423/609; 106/436; 106/437; 423/598

(57) ABSTRACT

An electrophotographic developing agent including an untreated toner including a binding resin, a black colorant, and a charge controlling agent, and an external additive added to a surface of the untreated toner, wherein the black colorant includes a titanium oxide. Accordingly, the electrophotographic developing agent has good mixing properties, dispersion properties, and heat resistance while maintaining proper image concentration. Also, the electrophotographic developing agent can be employed in an electrophotographic image forming apparatus.

### CROSS-REFERENCE TO RELATED APPLICATIONS

This application claims priority under 35 U.S.C. §119(a) from Korean Patent Application No.10-2005-0122436, filed on Dec. 13, 2005 in the Korean Intellectual Property Office, the disclosure of which is incorporated herein in its entirety by reference.

### BACKGROUND OF THE INVENTION

1. Field of the Invention

The present general inventive concept relates to an electrophotographic developing agent, and more particularly, to an electrophotographic developing agent which, while maintaining an appropriate image concentration, has good mixing properties, dispersion properties, and heat resistance, and is environment-friendly and not harmful to the human body.

2. Description of the Related Art

Generally, an electrophotographic image forming apparatus includes a developing unit, including a toner cartridge and a photosensitive medium, and a transferring unit and forms an electrostatic latent image by scanning light to the photosensitive medium which is charged with a predetermined potential. The electrostatic latent image is developed with toner and then transferred and fixed to a printing medium, thereby forming a visible image. Examples of the electrophotographic image forming apparatus include a laser printer, a facsimile machine, a copying machine, etc.

Generally, a developing agent in such an electrophotographic image forming apparatus refers to a toner mixed with carriers that facilitate a frictional charge of the toner, and if carriers are not mixed in the toner, the toner itself is referred to as the developing agent.

For example, dry type developing agents may be classified into one-component developing agents and two-component developing agents according to a charging type of an untreated toner, or into magnetic types and non-magnetic types depending on the transferring means of the charged untreated toner to a latent image unit on which an electrostatic latent image is formed. One-component developing agents denote developing agents which are charged by friction between untreated toners or by friction between an untreated toner and a sleeve. Two-component developing agents denote developing agents which are charged by friction between carriers and untreated toner by mixing the non-magnetic untreated toner and magnetic carrier particles. Also, a non-magnetic developing agent denotes a developing agent which does not use a magnetic force but is moved by the fluidity of the particles of the developing agent, and a magnetic developing agent denotes a developing agent that is moved by the magnetic force by mixing magnetic material such as ferrite in the developing agent.

FIG. 1 is a schematic view illustrating a general non-contact developing type electrophotographic image forming apparatus.

A non-magnetic one-component developing agent 8 in a developing apparatus 4 is supplied to a developing roller 5 by a supplying roller 6 formed of an elastic member such as polyurethane foam, sponge, etc.

The developing agent 8 supplied to the developing roller 5 arrives at a contact portion of a developing agent regulation blade 7 and the developing roller 5 as the developing roller 5 rotates. The developing agent regulation blade 7 may be formed of an elastic member such as metal, rubber, etc. The developing agent 8 passes through the contact portion of the developing agent regulation blade 7 and the developing roller 5 and is regulated to a predetermined thickness and becomes thin, and thus the developing agent 8 is sufficiently charged. The developing agent 8 regulated to the predetermined thickness is transferred to a developing region in which an electrostatic latent image of a photosensitive medium 1 is formed by the developing roller 5. At this time, the electrostatic latent image is formed by scanning light 3 to the photosensitive medium 1.

The developing roller 5 is separated a predetermined distance from and faces the photosensitive medium 1. The developing roller 5 may rotate in a counter-clockwise direction and the photosensitive medium 1 may then rotate in a clockwise direction.

The developing agent 8 transferred to the developing region of the photosensitive medium 1 develops an electrostatic latent image formed in the photosensitive medium 1 by an electric force generated by a potential difference of a voltage applied to the developing roller 5 from a power supply 12 and a potential of the latent image of the photosensitive medium 1 charged by a charging means 2 to form a toner image.

A toner image formed on the photosensitive medium 1 arrives at a transferring unit 9 according to the rotation direction of the photosensitive medium 1. A transfer bias voltage having an opposite polarity to the toner image is applied to the transferring unit 9 so that the toner image developed on the photosensitive medium 1 can be transferred to a printing medium 13. The toner image is transferred to the printing medium 13 by an electrostatic force between the photosensitive medium 1 and the transferring unit 9.

The toner image transferred to the printing medium 13 passes through a high temperature, high pressure fixing unit (not shown) and is fixed on the printing medium 13. Wasted developing agent 8′ which is not developed and remains in the developing roller 5 is collected by the supplying roller 6 which contacts the developing roller 5, and wasted developing agent 8′ which is not developed and remains in the photosensitive medium 1 is collected by a cleaning blade 10.

Untreated toner which is generally used as a developing agent may include a binding resin, a colorant, a charge controlling agent, and a releasing agent. An external additive may also be added to the surface of the untreated toner.

In the case of using a color image forming apparatus, the colors of the toner used as a developing agent are generally yellow (Y), magenta (M), cyan (C), and black (K). Accordingly, at least four different colorants must be used in a color image forming apparatus to realize each toner color.

Carbon black or Fe₃O₄ is conventionally used as the black colorant for the black toner.

However, carbon black is hydrophobic and thus is difficult to wet, and the particle diameter thereof is very small, generally about 0.005 μm. Thus carbon black does not have good mixing properties when being mixed with other colorants. Also, when carbon black is mass-produced industrially, 3,4-Benzopyrene, which is a carcinogenic substance, may be produced as a by-product, and this by-product may be partly mixed with the carbon black during the manufacture of the carbon black. Accordingly, when carbon black is used as a black colorant, it may cause environmental pollution and be harmful to the human body.

When carbon black or Fe₃O₄ is used as a colorant, the dispersion properties thereof may decrease and the heat resistance thereof is also low. Thus when Fe₃O₄ is exposed to a temperature of 150° C. or greater in the manufacturing process, the color thereof may change, which makes the manufacture of Fe3O4 difficult.

### SUMMARY OF THE INVENTION

The present general inventive concept provides an electrophotographic developing agent which is environment-friendly and not harmful to the human body.

The present general inventive concept also provides an electrophotographic developing agent which has good mixing properties, dispersion properties, and heat resistance while maintaining an appropriate image concentration.

The present general inventive concept also provides an electrophotographic developing agent having good acid resistance and alkali resistance.

The present general inventive concept also provides an electrophotographic developing agent having good electric conductivity, static electricity prevention effect, and electromagnetic wave absorption capacity.

The present general inventive concept also provides an electrophotographic image forming apparatus employing the electrophotographic developing agent.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept are achieved by providing an electrophotographic developing agent including untreated toner comprising a binding resin, a colorant, and a charge controlling agent, and an external additive added to a surface of the untreated toner, wherein the colorant comprises a titanium oxide.

The titanium oxide may be represented by the formula below:

TiₙO₂ₙ₋₁, where n is 1 or an integer greater than 1.

In the formula above, n may be 4.

The titanium oxide may be produced by reducing titanium dioxide.

The titanium oxide may be produced by reducing titanium dioxide with NaBH₄.

The titanium oxide may be produced by reducing the titanium dioxide at a reducing temperature of 300-950° C.

The untreated toner may further comprise a releasing agent.

The amount of titanium oxide in the untreated toner may be 5-15% by weight to 100% by weight of the total untreated toner.

The releasing agent may be selected from the group consisting of polyalkylene wax, ester wax, carnauba wax, and paraffin wax.

The binding resin may be a polyester based resin having a molecular weight of 30,000-100,000.

The external additive may comprise a large-size particle silica having a first mean particle diameter of 15-30 nm, a small-size particle silica having a first mean particle diameter of 3-14 nm, and polymer beads.

The amount of the large-size particle silica and the small-size particle silica may be respectively 0.1-3.0 parts by weight based on 100 parts by weight of the untreated toner.

The polymer beads may be melanine based polymer beads or polymethylmethacrylate (PMMA), and a first mean particle diameter of the polymer beads may be 200-300 nm.

The amount of the polymer beads may be 0.1 to 2.0 parts by weight based on 100 parts by weight of the untreated toner.

The foregoing and/or other aspects and utilities of the present general inventive concept are also achieved by providing an electrophotographic developing agent including an untreated toner, including a binding resin and a colorant, wherein the colorant comprises a titanium oxide.

The foregoing and/or other aspects and utilities of the present general inventive concept are also achieved by providing an electrophotographic image forming apparatus employing an electrophotographic developing agent, the electrophotographic developing agent including an untreated toner comprising a binding resin, a colorant, and a charge controlling agent, and an external additive added to a surface of the untreated toner, wherein the colorant comprises a titanium oxide.

The foregoing and/or other aspects and utilities of the present general inventive concept are also achieved by providing an electrophotographic image forming apparatus employing an electrophotographic developing agent, the electrophotographic developing agent including an untreated toner comprising a binding resin and a colorant, wherein the colorant comprises a titanium oxide.

The foregoing and/or other aspects and utilities of the present general inventive concept are also achieved by providing an electrophotographic image forming apparatus wherein an electrophotographic developing agent uses a titanium oxide as a colorant.

The foregoing and/or other aspects and utilities of the present general inventive concept are also achieved by providing an electrophotographic image forming apparatus capable of forming color images including a plurality of electrophotographic developing agents, wherein a titanium oxide is used as a colorant.

The foregoing and/or other aspects and utilities of the present general inventive concept are also achieved by providing a method of manufacturing titanium oxide for use as a colorant in an electrophotographic developing agent, the method including reducing titanium dioxide with a reducing agent to obtain titanium oxide.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a schematic view illustrating a general non-contact developing type electrophotographic image forming apparatus.

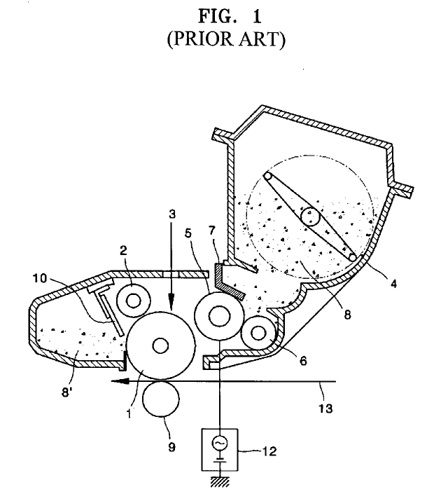

### DETAILED DESCRIPTION OF THE PREFERRED EMBODIMENTS

Reference will now be made in detail to the embodiments of the present general inventive concept, an example of which is illustrated in the accompanying drawing. The embodiments are described below in order to explain the present general inventive concept.

An electrophotographic developing agent according to an embodiment of the present general inventive concept may include an untreated toner and an external additive.

The untreated toner may include a binding resin, a colorant, and a charge controlling agent.

The binding resin is included in the untreated toner to hold other components of the electrophotographic developing agent, such as a colorant, a charge controlling agent, a releasing agent, and an external additive, and functions as an adhesive agent or a binder to bind the electrophotographic developing agent to a printing medium. Various known resins can be used as the binder resin. Examples of the binder resin include polystyrene, poly-p-chlorostyrene, poly-α-methylstyrene, styrene based copolymer such as styrene-chlorostyrene copolymer, styrene-propylene copolymer, styrene-vinyltoluene copolymer, styrene-vinylnaphthalene copolymer, styrene-methylacrylate copolymer, styrene-ethylacrylate copolymer, styrene-propylacrylate copolymer, styrene-butylacrylate copolymer, styrene-octylacrylate copolymer, styrene-methylmethacrylate copolymer, styrene-ethylmethacrylate copolymer, styrene-propylmethacrylate copolymer, styrene-butylmethacrylate copolymer, styrene-α-chloromethylmethacrylate copolymer, styrene-acrylonitrile copolymer, styrene-vinylmethylether copolymer, styrene-vinylethylether copolymer, styrene-vinylethylketone copolymer, styrene-butadiene copolymer, styrene-acrylonitrile-indene copolymer, styrene-maleic acid copolymer, and styrene-maleic ester; polymethylmethacrylate, polyethylmethacrylate, polybutylmethacrylate, and a copolymer thereof, polyvinyl chloride, polyvinyl acetate, polyethylene, polypropylene, polyester, polyurethane, polyamide, epoxy resin, polyvinylbutyral resin, rosin, modified rosin, terpene resin, phenol resin, aliphatic or alicyclic hydrocarbon resin, aromatic petroleum resin, chlorinated paraffin and paraffin wax, and the like, or a combination thereof. The biding resin may be used alone or in a mixture of two or more binder resins. Among these examples, polyester resin has good fixing properties and transparency and is thus appropriate for a color electrophotographic developing agent. In the present embodiment, a polyester type resin having a molecular weight of 30,000 through 100,000 is used as a binding resin.

A black colorant gives a black color to the electrophotographic developing agent, and the black colorant of the present embodiment is a titanium oxide. The titanium oxide is represented by the formula below:
TiₙO_{2n-1,} <Formula 1>

where n is 1 or an integer greater than 1.

In Formula 1, n is preferably 4, but is not limited thereto in the present general inventive concept. When n is 4 in Formula 1, that is, when titanium oxide is in the form of Ti₄O₇, the titanium oxide is black and has good chemical stability.

The titanium oxide may be formed by reducing titanium dioxide TiO₂ using a reducing agent such as NaBH₄ at a temperature of 300 to 950° C. Thus, as titanium dioxide is reduced by a predetermined reducing agent, a desired titanium oxide at a temperature lower than 500° C. may be obtained. That is, particle sintering can be prevented and a titanium oxide for a black colorant having desirable properties can be obtained. However, the present general inventive concept is not limited thereto, and titanium oxide may be formed using various other methods.

In the present embodiment, the amount of titanium oxide as the black colorant is in the range of about 5 to 15% by weight based on 100% by weight of the total untreated toner. The untreated toner may further include a releasing agent which will be described later.

The electrophotographic developing agent according to the present embodiment reflects the properties of the titanium oxide used as a black colorant, and thus is environment-friendly and not harmful to the human body. Also, the titanium oxide has better dispersion properties and heat resistance than conventional inorganic black colorants such as Fe₃O₄, and better mixing properties than a conventional carbon black and thus the electrophotographic developing agent including titanium oxide as a black colorant also has the same properties. In addition, titanium oxide itself has good electrical conductivity, static electricity prevention effect, and electromagnetic wave absorption capacity, and thus the electrophotographic developing agent using the titanium oxide as a colorant also has the same properties.

The electrophotographic developing agent may include other developing agents each including yellow, magenta, and cyan colorants besides the developing agent including a black colorant. The developing agents including different colorants may be employed in an electrophotographic image forming apparatus. An image forming apparatus in which only a developing agent including a black colorant is employed is called a black image forming apparatus, and an image forming apparatus in which four kinds of developing agents including four colorants are employed is called a color image forming apparatus.

That is, in a color image forming apparatus, a black developing agent includes a black colorant, and the other three color developing agents respectively include yellow, magenta, and cyan colorants.

Examples of the yellow colorant may include a condensed nitrogen compound, an isoindolynone compound, an anthraquin compound, azo metal complex, and allyl imide compound. In detail, C.I. pigment yellow 12, 13, 14, 17, 62, 74, 83, 93, 94, 95, 109, 110, 111, 128, 129, 147, or 168 may be used.

Examples of the magenta colorant may include a condensed nitrogen compound, anthraquin, quinacridone compound, basic dye lake compound, naphthol compound, benzo imidazole compound, thioindigo compound, and perylene compound. In detail, C.I. pigment red 2, 3, 5, 6, 7, 23, 48:2, 48:3, 48:4, 57:1, 81:1,144, 146, 166, 169, 177, 184, 185, 202, 206, 220, 221, or 254 may be used.

Examples of the cyan colorant may include copper phthalocyanine compound and derivatives thereof, anthraquin compound, and basic dye lake compound. In detail, C.I. pigment blue 1, 7,15, 15:1,15:2, 15:3, 15:4, 60, 62, or 66 may be used.

The colorant in each electrophotographic developing agent can be used alone. However, the present general inventive concept is not limited thereto, and at least two of the colorants may be mixed and used as a mixture in each electrophotographic developing agent. Whether the colorants are mixed or not, and the ratio of mixing may be decided in consideration of the color, chroma, brightness, weatherability, and dispersion property in the toner.

The amount of the colorant is sufficient when the colorant can form a visible image by coloring and developing the toner, for example, about 2 to 20 parts by weight based on 100 parts by weight of the binding resin. When the amount of the colorant is less than 2 parts by weight, the coloring effect may not be sufficient, and when the amount of the colorant is greater than 20 parts by weight, the electrical resistance of the developing agent may become low and no sufficient frictional charge amount may be obtained, thereby creating pollution.

The charge controlling agent may be a negative-charge type charge controlling agent or a positive-charge type charge controlling agent. Examples of the negative-charge type charge controlling agent include organometallic complex such as chrome-containing azo dyes or monoazo metal complex or chelating compound, metal-containing salicyclic compound such as chrome, iron, zinc, and the like, and organometallic complex of aromatic hydroxycarboxylic acid or aromatic dicarboxylic acid. However, other know materials may be used as the charge controlling agent. Examples of the positive-charge type charge controlling agent include a product which is modified with nigrocine and its fatty acid metal salt, and the like, and an onium salt including a quaternary ammonium salt such as tributylbenzylammonium 1-hydroxy-4-naphthosulfonate, and the like, tetrabutylammoniumtetrafluoroborate, which can be used alone or in combination of two or more. These charge controlling agents charge an electrophotographic developing agent by an electrostatic force stably and rapidly, thereby supporting the electrophotographic developing agent on a developing roller.

The amount of the charge controlling agent included in the electrophotographic developing agent is in the range of about 0.1 to 10% by weight based on 100% by weight of the total electrophotographic developing agent.

The untreated toner according to the present embodiment may further include a releasing agent which can improve the fixing property of the toner image. Examples of the releasing agent may include polyalkylene wax such as low molecular weight polypropylene, low molecular polyethylene, and the like, ester wax, carnauba wax, paraffin wax, and the like.

Also, the untreated toner may further include a high grade aliphatic acid or a metal salt thereof such as aliphatic acid amide. The high grade aliphatic acid and the metal salt thereof can be used to obtain a high quality image by protecting the photosensitive medium and preventing deterioration of the developing characteristic.

Examples of the external additive may include large-size particle silica, small-size particle silica, and polymer beads.

These external additives may be included in the untreated toner in order to add fluidity, charge stability, and cleaning properties to the electrophotographic developing agent.

When an external additive is added, two or more kinds of external additives having different first mean particle diameters may be used in combination in order to prevent the external additive from being separated from the surface of the untreated toner or to prevent the external additive from being buried in the surface of the untreated toner, which causes image deterioration.

In the present embodiment, the external additive includes a large-size particle silica having a first mean particle diameter of 15 to 30 nm and a small-size particle silica having a first mean particle diameter of 3 to 14 nm. The large-size particle silica may be a spacer particle to prevent deterioration of the developing agent and increase the transferring efficiency. The small-size particle may give fluidity to the developing agent.

The amount of the large-size particle silica and the small-size particle silica is respectively about 0.1 to 3.0 parts by weight based on 100 parts by weight of the untreated toner. If the amount is less than 0.1 parts by weight, the advantages due to addition of the silica may be difficult to obtain. If the amount is greater than 3.0 parts by weight, the fixing properties may deteriorate and overcharging and bad cleaning may result. The surface of the large-size particle silica and the small-size particle silica may be treated using at least two surface treating agents selected from the group consisting of organosilazane, polysiloxane, organofunctional siloxane, and the like.

Also, an external additive may include an inorganic corpuscle such as zinc oxide or aluminum oxide besides silica.

Polymer beads prevent image pollution due to the pollution of a developing member, and examples of the polymer beads are melanine based polymer beads and polymethylmethacrylate (PMMA). A first mean particle diameter of the polymer beads is preferably in a range of about 0.1 to 3 μm, and can be about 200 to 300 nm. If the first mean particle diameter is less than 0.1 μm, the effect caused by polymer beads may not be expectable and if the first mean particle diameter is greater than 3 μm, the polymer beads may be likely to separate from the untreated toner. Melanine based polymer beads or PMMA may be used as polymer beads alone or in combination. The total amount of the used polymer beads is about 0.1 to 2.0 parts by weight based on 100 parts by weight of the untreated toner. If the amount of the polymer beads is less than 0.1 parts by weight, the effect caused by the polymer beads is not expectable as above, and if the amount is greater than 2.0 parts by weight, the polymer beads may be likely to separate from the untreated toner or to condense by themselves.

Hereinafter, a method of manufacturing an electrophotographic developing agent will be described in detail.

First, colorants may be treated so as to be dispersed uniformly in the binding resin. For this, the colorants may be flushed in advance or fused and kneaded with a binding resin at high concentration using a master batch. For example, the binding resin and the colorant may be mixed using a kneading unit such as a two-roll, three-roll, press kneader, or two-axis extruder. The mixture of the binding resin and the colorant is fused and kneaded at a temperature from about 80 to 180° C. for 10 minutes to 2 hours. Then the mixture is finely pulverized using a jet mill, a friction mill, or a rotating mill, and thus untreated toner having a first mean particle diameter from 3 to 15 μm may be produced. An external additive, which will be described later, may be added to the untreated toner, thereby improving powder fluidity or charge stability.

The electrophotographic developing agent according to the present embodiment may also be manufactured using a polymerization method besides the fusion-kneading pulverization method.

For the external additive to be attached to the untreated toner, the untreated toner and the external additive may be mixed in a predetermined ratio and loaded in a Henschel mixer and agitated, the external additive being pasted on the surface of the untreated toner. Alternatively, both the external additive and the untreated toner may be installed in a surface modifier such as ‘NARA HYBRIDIZER’ and agitated such that at least a portion of the external additive is buried on the surface of the untreated toner.

The electrophotographic developing agent according to the present embodiment can also be employed in a contact type nonmagnetic one-component developing toner besides an electrophotographic image forming apparatus employing a non-contact type nonmagnetic one-component toner. A contact type refers to a method in which an electrostatic latent image is developed by an electrophotographic developing agent in that the developing roller and the surface of the photosensitive medium contact each other. A non-contact type refers to a method in which the developing roller and the surface of the photosensitive medium are separated by a predetermined distance and the electrophotographic developing agent is moved and developed by the electric force which is generated by the potential difference between the voltage applied to the developing roller and the latent image potential of the photosensitive medium.

Hereinafter, the present general inventive concept will be described in more detail with reference to the following examples. However, these examples are not intended to limit the scope of the general inventive concept.

### EXAMPLE

Manufacture of Untreated Toner

A binding resin, a colorant, a charge controlling agent, and a releasing agent were mixed in a predetermined ratio preliminarily using a Henschel type mixer. Next, the mixture was put into a two-axis extrusion kneader to extrude a fusion mixture at 120° C. and to cool and solidify the mixture. Then using a mill/classifying system (TC-15 available from Nissin engineering), untreated toner having a mean particle diameter of about 10 μm before external additive treatment was obtained.

External Additive Process

The untreated toner manufactured using the above described pulverization method was treated with an external additive to manufacture developing agents of Examples 1 and 2 of the present general inventive concept and of a Comparative Example.

Based on 100 parts by weight of the untreated toner,

1.0 parts by weight of large-size-particle silica (first mean particle diameter 15-30 nm), 1.0 parts by weight of small-size-particle silica (first mean particle diameter 3-14 nm), and 0.5 parts by weight of polymethylmethacrylate beads (first mean particle diameter 200-300 nm) were added to the untreated toner and mixed using a Henschel type mixer for about 3 minutes to treat with an external additive.

### Example 1

Binder resin: 86% by weight polyester based resin having a molecular weight of about 30,000-100,000

Releasing agent: 2% by weight carnauba wax (available from TOA Casei)

Colorant: 10% by weight of titanium oxide, Ti₄O₇ (manufactured by reducing TiO₂ using NaBH₄ in the present embodiment)

Negative-charge type charge controlling agent: 2% by weight of T-77 (available from Hodogaya)

### Example 2

Binder resin: 90% by weight polyester based resin having a molecular weight of about 30,000-100,000

Releasing agent: 2% by weight carnauba wax (available from TOA Casei)

Colorant: 6% by weight of titanium oxide, Ti₄O₇ (manufactured by reducing TiO₂ using NaBH₄ in the present embodiment)

Negative-charge type charge controlling agent: 2% by weight of T-77 (available from Hodogaya)

### Comparative Example 1

Binder resin: 93% by weight polyester based resin having a molecular weight of about 30,000-100,000

Releasing agent: 2% by weight carnauba wax (available from TOA Casei)

Colorant: Carbon black, 3% by weight of Mogul-L (available from Mitsubishi Chemical Co., Ltd.)

Negative-charge type charge controlling agent: 2% by weight of T-77 (available from Hodogaya)<

<Image Evaluation Test>

The developing agents manufactured using the above methods were employed in an actual image forming apparatus to print images. The concentrations of the printed images are illustrated in Table 1. A laser printer was used as the image forming apparatus (ML-1710 available from Samsung Electronics). The concentrations of the printed images were measured using a SpectroEye available from Macbath. The concentrations of the images were measured from nine spots, that is, upper, middle, and lower positions each corresponding to left, middle, and right positions of the printing medium on which the images were formed and the average values of the concentrations are illustrated in Table 1.

<Results of Image Evaluation Test>

TABLE 1
<Image concentration>

| | Solid image | 2 × 2 image | Toner charge amount |
|---|---|---|---|
| | concentration | concentration | on developing roller |
| Example 1 | 1.43 | 0.38 | −18 μC/mg |
| Example 2 | 1.28 | 0.31 | −22 μC/mg |
| Comparative | 1.31 | 0.33 | −23 μC/mg |
| example 1 | | | |

As the experimental results in Table 1 illustrate, the solid image concentration and the 2×2 image concentration show no remarkable difference between Examples 1 and 2 and Comparative example 1. Accordingly, when titanium oxide is used as a black colorant, an appropriate image concentration as in the case of using a conventional carbon black is obtained. At the same time, the disadvantages of using carbon black as a black colorant are avoided and the advantages of the titanium oxide are achieved as they are.

The developing agent according to the present general inventive concept may also be employed in a contact type nonmagnetic one-component developing agent besides an electrophotographic apparatus in which a non-contact type nonmagnetic one-component developing agent is used.

According to the present general inventive concept, an electrophotographic developing agent which is not harmful to the human body may be provided.

Also, according to the present general inventive concept, an electrophotographic developing agent having good mixing properties, dispersion properties, and heat resistance may be provided while maintaining proper image concentration.

Also, according to the present general inventive concept, an electrophotographic developing agent having acid resistance and alkali resistance may be provided.

Also, according to the present general inventive concept, an electrophotographic developing agent having good electrical conductivity, anti-electrostatic effects, and electromagnetic wave absorption capacity may be provided.

Also, according to the present general inventive concept, an electrophotographic image forming apparatus employing the developing agent may be provided.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An electrophotographic developing agent comprising:
untreated toner comprising a binding resin, a colorant, and a charge controlling agent; and
an external additive added to a surface of the untreated toner,
wherein the colorant comprises a titanium oxide.

2. The electrophotographic developing agent of claim 1, wherein the titanium oxide is represented by the formula below:
TiₙO₂ₙ₋₁,
where n is 1 or an integer greater than 1.

3. The electrophotographic developing agent of claim 2, wherein n is 4.

4. The electrophotographic developing agent of claim 1, wherein the titanium oxide is produced by reducing titanium dioxide.

5. The electrophotographic developing agent of claim 4, wherein the titanium oxide is produced by reducing titanium dioxide with NaBH₄.

6. The electrophotographic developing agent of claim 4, wherein the titanium oxide is produced by reducing the titanium dioxide at a reducing temperature of 300-950° C.

7. The electrophotographic developing agent of claim 1, wherein the untreated toner further comprises:
a releasing agent.

8. The electrophotographic developing agent of claim 7, wherein the amount of titanium oxide in the untreated toner is 5-15% by weight to 100% by weight of the total untreated toner.

9. The electrophotographic developing agent of claim 7, wherein the releasing agent is selected from the group consisting of polyalkylene wax, ester wax, carnauba wax, and paraffin wax.

10. The electrophotographic developing agent of claim 1, wherein the binding resin is a polyester based resin having a molecular weight of 30,000-100,000.

11. The electrophotographic developing agent of claim 1, wherein the external additive comprises:
a large-size particle silica having a first mean particle diameter of 15-30 nm;
a small-size particle having a first mean particle diameter of 3-14 nm; and polymer beads.

12. The electrophotographic developing agent of claim 11, wherein the amount of the large-size particle and the small-size particle is respectively 0.1-3.0 parts by weight based on 100 parts by weight of the untreated toner.

13. The electrophotographic developing agent of claim 11, wherein the polymer beads are melanine based polymer beads or polymethylmethacrylate, and the first mean particle diameter of the polymer beads is 200-300 nm.

14. The electrophotographic developing agent of claim 11, wherein the amount of the polymer beads is 0.1 to 2.0 parts by weight based on 100 parts by weight of the untreated toner.

15. The electrophotographic developing agent of claim 1, wherein the colorant is a black colorant.

16. An electrophotographic developing agent comprising:
an untreated toner comprising:
a binding resin; and
a colorant;
wherein the colorant comprises a titanium oxide.

17. The electrophotographic developing agent of claim 16, wherein the untreated toner further comprises:
a charge controlling agent.

18. The electrophotographic developing agent of claim 17, further comprising:
an external additive added to a surface of the untreated toner.

19. An electrophotographic image forming apparatus employing an electrophotographic developing agent, the electrophotographic developing agent comprising:
untreated toner comprising a binding resin, a colorant, and a charge controlling agent; and
an external additive added to a surface of the untreated toner,
wherein the colorant comprises a titanium oxide.

20. An electrophotographic image forming apparatus employing an electrophotographic developing agent, the electrophotographic developing agent comprising:
man untreated toner comprising:
a binding resin; and
a colorant;
wherein the colorant comprises a titanium oxide.

21. An electrophotographic image forming apparatus wherein an electrophotographic developing agent uses a titanium oxide as a colorant.

22. The electrophotographic image forming apparatus of claim 21, wherein the colorant used by the electrophotographic developing agent is a black colorant.

23. An electrophotographic image forming apparatus capable of forming color images comprising:
a plurality of electrophotographic developing agents, wherein a titanium oxide is used as a colorant.

24. The electrophotographic image forming apparatus of claim 23, wherein the colorant using the titanium oxide is a black colorant

25. A method of manufacturing titanium oxide for use as a colorant in an electrophotographic developing agent, comprising:
reducing titanium dioxide with a reducing agent to obtain titanium oxide.

26. The method of claim 25, wherein the reducing agent is NaBH₄.

27. The method of claim 25, wherein titanium oxide is produced by reducing the titanium dioxide at a reducing temperature of 300-950° C.
